(19) United States
(12) Patent Application Publication
(10) Pub. No.: US 2026/0312087 A1
(43) Pub. Date: Oct. 8, 2026

(54) MANAGING A FUEL CELL SYSTEM IN A FUEL CELL VEHICLE

(71) Applicant: VOLVO TRUCK CORPORATION, Göteborg (SE)

(72) Inventors: Pranav ARYA, Lindome (SE); Ricard BLANC, Mölndal (SE)

(73) Assignee: VOLVO TRUCK CORPORATION, Göteborg (SE)

(21) Appl. No.: 19/482,322

(22) PCT Filed: May 12, 2023
(86) PCT No.: PCT/EP2023/062827

§ 371 Date: Nov. 7, 2025

(51) Int. Cl. H01M 8/04089; B60L 58/31; H01M 8/04225; H01M 8/04228; H01M 8/04302; H01M 8/04303

(52) U.S. Cl. CPC H01M 8/04089; B60L 58/31; H01M 8/04225; H01M 8/04228; H01M 8/04302; H01M 8/04303; B60L 2200/40; B60L 2240/66; B60L 2250/22; B60L 2260/44; H01M 2250/20

(57) ABSTRACT

A system and method for controlling operation of a fuel cell system of a fuel cell vehicle are provided. The fuel cell system has a fuel cell stack comprising an anode side and a cathode side, and a hydrogen storage device for storing hydrogen supplied to the anode side of the fuel cell stack. The method includes estimating a duration of a stopover of the vehicle when a request to shut down the fuel cell system is received, estimating a hydrogen protection time at least due to a first hydrogen refill comprising supplying the hydrogen to the anode side of the fuel cell stack from the hydrogen storage device, and determining, based at least on the estimated duration of the stopover and the hydrogen protection time, whether to enable or disable one or both the first hydrogen refill operation and at least one subsequent hydrogen refill operation.

### TECHNICAL FIELD

The disclosure relates generally to operating a fuel cell system in a fuel cell vehicle. It further relates to a control system, a fuel cell vehicle, a computer program product, and a computer-readable medium.

The disclosure can be applied in heavy-duty vehicles, such as trucks, buses, and construction equipment.

### BACKGROUND

A fuel cell is an electro-chemical device that includes an electrolyte sandwiched between two electrodes such as an anode and a cathode. Solid polymer electrolyte fuel cells, which employ a proton exchange, solid polymer membrane electrolyte, electrochemically convert reactants-fuel (such as hydrogen) received at the anode or anode side, and oxidant (such as oxygen or air) received at the cathode or cathode side, to generate electric power. Two or more, typically several hundred, fuel cells are usually arranged together into a fuel cell stack, in order to provide a higher output voltage. One or more fuel cell stacks may form a fuel cell system. Proton exchange membrane (PEM) fuel cells are considered well suitable for vehicular applications, and PEM fuel cells electric vehicles have recently received increased attention due to the advantages of low or zero emissions.

In use, fuel cell systems, particularly in vehicles, may be subjected to relatively frequent starts and shutdowns. It is generally desirable to be able to reliably start a fuel cell system in a short period of time. At the same time, a fuel cell system suffers from degradation at each start-up, which shortens a lifetime of the fuel cell system. Moreover, a risk of degradation increases with the increase in the length of a shutdown period. This can occur due to a so-called air-to-air start or start-up, also referred to as an air/air start-up, which happens when air or oxygen is present at the start of the fuel cell system both in the anode and in the cathode.

When a fuel cell system is shut down, the stack of the system can be left with an excess of ambient air or oxygen, and the oxygen may leak into the stack, specifically penetrate the membrane to the anode and cause the onset of a hydrogen/air, also referred to as an air/hydrogen, front. The front develops when the fuel cell system is started again and the hydrogen fuel injected into the anode displaces the leaked air. The simultaneous presence of both air and hydrogen at the anode causes a rise of the local potential at the cathode to values as high as e.g. 1.5 V. A locally high potential may thereby be generated between the cathode side and the air-filled section of the anode side, adjacent to the electrolyte. This mechanism may lead to a rapid and severe corrosion of the cathode catalyst, thereby reducing performance and durability of the fuel cell system.

Various methods have been proposed to avoid an air-to-air start of a fuel cell system or to limit a number of air-to-air starts during a life of the fuel cell system. However, a need remains for improved methods for operating a fuel cell system in a way that reduces degradation of the fuel cell system, particularly due to an air-to-air start-up.

### SUMMARY

Aspects of the present disclosure relate to control of operation of a fuel cell system in a vehicle in a manner that increases durability and prolongs a lifetime of the fuel cell system, by determining when to refill hydrogen at an anode side of the fuel cell system and thereby reduce a number of air-to-air starts. The present disclosure alleviates the problem of a fuel cell system degradation at each start-up, while considering the cost of hydrogen refills which may be required to replenish hydrogen at the anode side.

According to an aspect of the disclosure, a method for controlling operation of a fuel cell system of a fuel cell vehicle is provided, the fuel cell system comprising a fuel cell stack comprising an anode side and a cathode side, and a hydrogen storage device for storing hydrogen supplied to the fuel cell stack. The method comprises estimating a duration of a stopover of the vehicle when a request to shut down the fuel cell system is received, estimating a hydrogen protection time at least due to a first hydrogen refill operation comprising supplying the hydrogen to the anode side of the fuel cell stack from the hydrogen storage device, and determining, based at least on the estimated duration of the stopover and the hydrogen protection time, whether to enable or disable one or both the first hydrogen refill operation and at least one subsequent hydrogen refill operation.

The technical benefits include a reduced number of occurrences of air-to-air starts of a fuel cell system. In some examples, air-to-air starts are eliminated. In this way, a risk of degradation of the fuel cell system is decreased, thereby increasing a lifetime of the fuel cell system. Furthermore, operation costs of the fuel cell system and the vehicle are reduced, due to balancing the cost of hydrogen consumption for refilling the anode side of the fuel cell system with a degradation cost of the fuel cell system.

In some examples, the duration of a stopover of the vehicle may be estimated using at least one of a driver input and historical data. In some examples, the hydrogen protection time may be estimated using at least current and predicted ambient conditions. In some examples, the duration of a stopover of the vehicle and the hydrogen protection time may be estimated using information on a location of the vehicle.

In some examples, the method further comprises determining whether a driver of the vehicle is present in the vehicle during the stopover for a certain time period. In some examples, determining whether the driver of the vehicle is present in the vehicle during the stopover for the certain time period comprises determining whether the driver is sleeping or living in the vehicle.

In some examples, the method further comprises, responsive to determining that the driver of the vehicle is present in the vehicle during the stopover for the certain time period, determining power needs of the fuel cell vehicle during the vehicle stopover; and determining whether the fuel cell system is to be restarted during the stopover to meet the determined power needs of the fuel cell vehicle during the stopover of the vehicle.

In some examples, the determining whether the fuel cell system is to be restarted during the stopover comprises determining whether an electric energy storage of the vehicle is capable of fulfilling the determined power needs of the fuel cell vehicle during the stopover of the vehicle.

In some examples, the method further comprises, responsive to determining that the driver is not present in the vehicle during the stopover for the certain time period or responsive to determining that the fuel cell system is not to be restarted to meet the determined power needs of the fuel cell vehicle during the vehicle stopover, comparing the duration of the stopover of the vehicle to the hydrogen protection time due to the first hydrogen refill operation.

In some examples, the method further comprises, responsive to determining that the duration of the stopover of the vehicle is shorter than the hydrogen protection time due to the first hydrogen refill operation, disabling the at least one subsequent hydrogen refill operation. This advantageously allows increasing the efficiency of operating the fuel cell system, by saving costs of hydrogen responsive to determining that the fuel cell system will be restarted at the end of the stopover of the vehicle, before the hydrogen protection time expires.

In some examples, the method further comprises, responsive to determining that the fuel cell system is to be restarted to meet the determined power needs of the fuel cell vehicle during the vehicle stopover, determining whether a restart of the fuel cell system during the stopover is expected before an expiration of the hydrogen protection time due to the first hydrogen refill operation.

In some examples, the method further comprises, responsive to determining that the restart of the fuel cell system during the stopover is expected before the expiration of the hydrogen protection time, disabling the at least one subsequent hydrogen refill operation. The technical benefit includes increasing the efficiency of operating the fuel cell system.

In some examples, the method further comprises, responsive to determining that the duration of the stopover of the vehicle is greater than the hydrogen protection time due to the first hydrogen refill operation or responsive to determining that the restart of the fuel cell system during the stopover is not expected after the expiration of the hydrogen protection start due to the first hydrogen refill operation, estimating an additional amount of hydrogen required to increase the hydrogen protection time due to the first hydrogen refill.

In some examples, the method further comprises comparing an expected cost of the additional amount of hydrogen and an expected cost of degradation of the fuel cell system due to a subsequent air-to-air start of the fuel cell system; and enabling the first hydrogen refill operation and the at least one subsequent hydrogen refill operation responsive to determining that the expected cost of the additional amount of hydrogen is lower than the expected cost of degradation of the fuel cell system due to the subsequent air-to-air start of the fuel cell system.

The technical benefits of enabling the first hydrogen refill operation and the at least one subsequent hydrogen refill operation comprises reducing a risk of degradation of the fuel cell system of the fuel cell electric vehicle, thereby increasing the performance and reliability of the fuel cell system and prolonging the lifetime of the fuel cell system.

In some examples, the method further comprises disabling both the first hydrogen refill operation and the at least one subsequent hydrogen refill operation responsive to determining that the expected cost of the additional amount of hydrogen is greater than the expected cost of degradation of the fuel cell system due to the subsequent air-to-air start of the fuel cell system.

Accordingly, responsive to determining that an estimated cost of hydrogen, that would be required for hydrogen refills to ensure a non-interrupted hydrogen protection time during the vehicle stopover and while the fuel cell system is shut down, exceeds an estimated cost of degradation of the fuel cell system due to an air-to-air start that may ensue, all hydrogen refills may be disabled and a risk of a damage to the fuel cell system due to the air-to-air start may be accepted. In this way, hydrogen consumption is reduced. The technical benefits also include increasing the efficiency of operating the fuel cell system in a fuel cell vehicle.

According to an aspect of the disclosure, a control system for controlling a fuel cell system of a fuel cell vehicle is provided. The control system comprises processing circuitry. The fuel cell system comprises a fuel cell stack comprising an anode side and a cathode side, and the fuel cell system comprises a hydrogen storage device for storing hydrogen supplied to the fuel cell stack. The processing circuitry of the control system is configured to estimate a duration of a stopover of the vehicle when a request to shut down the fuel cell system is received; estimate a hydrogen protection time at least due to a first hydrogen refill operation comprising supplying the hydrogen to the anode side of the fuel cell stack from the hydrogen storage device; and determine, based at least on the estimated duration of the stopover and the hydrogen protection time, whether to enable or disable one or both the first hydrogen refill operation and at least one subsequent hydrogen refill operation.

In some examples, the processing circuitry of the control system is configured to perform the method in accordance with examples of the present disclosure.

The technical benefits include a reduced number of occurrences of air-to-air starts of a fuel cell system. In some examples, air-to-air starts are eliminated. In this way, a risk of degradation of the fuel cell system is decreased, thereby increasing a lifetime of the fuel cell system. Furthermore, operation costs of the fuel cell system and the vehicle are reduced, due to balancing the cost of hydrogen consumption for refilling the anode side of the fuel cell system with a degradation cost of the fuel cell system.

In some examples, in the control system, the duration of a stopover of the vehicle may be estimated using at least one of a driver input and historical data. In some examples, the hydrogen protection time may be estimated using at least current and predicted ambient conditions. In some examples, the duration of a stopover of the vehicle and the hydrogen protection time may be estimated using information on a location of the vehicle.

In some examples, the processing circuitry of the control system is configured to determine whether a driver of the vehicle is present in the vehicle during the stopover for a certain time period. In some examples, determining whether the driver of the vehicle is present in the vehicle during the stopover for the certain time period comprises determining whether the driver is sleeping or living in the vehicle.

In some examples, the processing circuitry of the control system is configured to, responsive to determining that the driver of the vehicle is present in the vehicle during the stopover for the certain time period, determine power needs of the fuel cell vehicle during the vehicle stopover; and determine whether the fuel cell system is to be restarted during the stopover to meet the determined power needs of the fuel cell vehicle during the stopover of the vehicle.

In some examples, the determining whether the fuel cell system is to be restarted during the stopover comprises determining whether an electric energy storage of the vehicle is capable of fulfilling the determined power needs of the fuel cell vehicle during the stopover of the vehicle.

In some examples, the processing circuitry of the control system is configured to, responsive to determining that the driver is not present in the vehicle during the stopover for the certain time period or responsive to determining that the fuel cell system is not to be restarted to meet the determined power needs of the fuel cell vehicle during the vehicle stopover, compare the duration of the stopover of the vehicle to the hydrogen protection time due to the first hydrogen refill operation.

In some examples, the processing circuitry of the control system is configured to, responsive to determining that the duration of the stopover of the vehicle is shorter than the hydrogen protection time due to the first hydrogen refill operation, disable the at least one subsequent hydrogen refill operation. This advantageously allows increasing the efficiency and performance of operating the fuel cell system, and of the vehicle.

In some examples, the processing circuitry of the control system is configured to, responsive to determining that the fuel cell system is to be restarted to meet the determined power needs of the fuel cell vehicle during the vehicle stopover, determine whether a restart of the fuel cell system during the stopover is expected before an expiration of the hydrogen protection time due to the first hydrogen refill operation.

In some examples, the processing circuitry of the control system is configured to, responsive to determining that the restart of the fuel cell system during the stopover is expected before the expiration of the hydrogen protection time, disable the at least one subsequent hydrogen refill operation. The technical benefit includes increasing the efficiency of operating the fuel cell system.

In some examples, the processing circuitry of the control system is configured to, responsive to determining that the duration of the stopover of the vehicle is greater than the hydrogen protection time due to the first hydrogen refill operation or responsive to determining that the restart of the fuel cell system during the stopover is not expected after the expiration of the hydrogen protection start due to the first hydrogen refill operation, estimate an additional amount of hydrogen required to increase the hydrogen protection time due to the first hydrogen refill.

In some examples, the processing circuitry of the control system is configured to compare an expected cost of the additional amount of hydrogen and an expected cost of degradation of the fuel cell system due to a subsequent air-to-air start of the fuel cell system; and enable the first hydrogen refill operation and the at least one subsequent hydrogen refill operation responsive to determining that the expected cost of the additional amount of hydrogen is lower than the expected cost of degradation of the fuel cell system due to the subsequent air-to-air start of the fuel cell system.

The technical benefits of enabling the first hydrogen refill operation and the at least one subsequent hydrogen refill operation comprises reducing a risk of degradation of the fuel cell system of the fuel cell electric vehicle, thereby increasing the performance and reliability of the fuel cell system and prolonging the lifetime of the fuel cell system.

In some examples, the processing circuitry of the control system is configured to disable both the first hydrogen refill operation and the at least one subsequent hydrogen refill operation responsive to determining that the expected cost of the additional amount of hydrogen is greater than the expected cost of degradation of the fuel cell system due to the subsequent air-to-air start of the fuel cell system.

According to an aspect of the disclosure, a fuel cell vehicle is provided comprising the control system that is configured to perform the method in accordance with examples of the present disclosure.

According to an aspect of the disclosure, a fuel cell vehicle is provided that is in communication with the control system that is configured to perform the method in accordance with examples of the present disclosure.

According to an aspect of the disclosure, a computer program product comprising instructions, which, when executed by processing circuitry, cause the processing circuitry to perform the method in accordance with examples of the present disclosure.

According to an aspect of the disclosure, a computer-readable storage medium is provided. The computer-readable storage medium has stored thereon a computer program product comprising instructions which, when executed by processing circuitry, cause the processing circuitry to perform the method in accordance with examples of the present disclosure.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

With reference to the appended drawings, below follows a more detailed description of aspects of the disclosure cited as examples.

FIG. 1 illustrates a side view of an example of a vehicle comprising a power assembly in which a method in accordance with aspects of the present disclosure may be implemented.

FIG. 2 is a block diagram illustrating a fuel cell system and a controller, in accordance with an example.

FIG. 3 is a flow chart illustrating a method for controlling operation of a fuel cell system of a fuel cell vehicle, in accordance with an example.

FIG. 4 is another flow chart illustrating a method for controlling operation of a fuel cell system of a fuel cell vehicle, in accordance with an example.

FIGS. 5A and 5B are schematic block diagrams illustrating examples of a control system, in accordance with aspects of the present disclosure.

### DETAILED DESCRIPTION

Fuel cell systems suffer from degradation at each start-up, which presents serious concerns regarding using fuel cells safely and reliably in various applications, particularly in automotive applications. The risk of degradation is typically higher if a shutdown that preceded a start-up lasts longer, due to possible conditions that lead to an air-to-air start. An air-to-air start of a fuel cell system, which involves accumulation of air at the anode side of a fuel cell of the fuel cell system, may cause significant and irreversible damage to the fuel cell system. Existing approaches to mitigating such events include pressurizing the anode side with hydrogen at the time of a shutdown of the fuel cell system, which results in some protection against subsequent accumulation of air at the anode side. The time over which hydrogen is kept in the anode side, e.g. after switching off the fuel cell system, until there is air in both the anode side and in the cathode side of the fuel cell, is generally referred to as “hydrogen protection time”. The hydrogen protection time lasts while there is hydrogen at the anode side, and the hydrogen protection time can be said to expire when air-to-air start conditions are created, i.e. conditions which would result in an air-to-air start upon a next start of the fuel cell system.

A hydrogen protection time can be extended by supplying hydrogen to the anode side while the fuel cell system is being shut down. This can be performed repeatedly and for a long time. However, such measures result in increased hydrogen consumption which increases operating costs of fuel cell systems. Moreover, a portion of the injected hydrogen may diffuse to the outside, resulting in waste of hydrogen. In addition, an oversupply of hydrogen may lead to high cross or differential pressure due to higher pressure at the anode side.

Thus, there is a need to control operation of the fuel cell system so that air-to-air starts are avoided or their number is reduced. A technique in accordance with aspects of the present disclosure addresses this need. Because the hydrogen injected into the anode side, to prolong a hydrogen protection time, dissipates with time e.g. by reaction with oxygen or due to leakages, repeated refills of the anode side with hydrogen may be required to prevent an air-to-air start. Such an approach however increases costs of hydrogen consumption.

Accordingly, aspects of the present disclosure provide a method that allows balancing the cost of hydrogen consumption, e.g. for refilling the anode side of a fuel cell system, with what is acceptable as a degradation cost of the fuel cell system. The method provided herein allows determining whether to fill or refill the anode side with hydrogen during and/or after a shutdown of the fuel cell system of a fuel cell vehicle. In this way, a hydrogen protection time for the fuel cell system may be maintained and increased. The hydrogen protection allows avoiding an air-to-air start upon a restart of the fuel cell system. Furthermore, in some cases, as a result of balancing acceptable costs of degradation of the fuel cell system with costs of hydrogen that would be required for one or more hydrogen refills, less hydrogen may be consumed which saves costs of operating of the fuel cell system in a vehicle.

Accordingly, a method for controlling operation of a fuel cell system of a fuel cell vehicle is provided. The fuel cell system comprises a fuel cell stack comprising an anode side and a cathode side, and a hydrogen storage device for storing hydrogen supplied to the fuel cell stack. The method comprises estimating a duration of a stopover of the vehicle when a request to shut down the fuel cell system is received, estimating a hydrogen protection time due to a first hydrogen refill operation comprising supplying the hydrogen to the anode side of the fuel cell stack from the hydrogen storage device; and determining, based at least on the estimated duration of the stopover and the hydrogen protection time, whether to enable or disable one or both the first hydrogen refill operation and at least one subsequent hydrogen refill operation. It should be noted that the hydrogen refill operation takes place when the fuel cell system is not producing power.

Also, a control system for controlling a fuel cell system of a fuel cell vehicle is provided. The control system comprises processing circuitry. The fuel cell system comprises a fuel cell stack comprising an anode side and a cathode side, and a hydrogen storage device for storing hydrogen supplied to the fuel cell stack. The processing circuitry of the control system is configured to estimate a duration of a stopover of the vehicle when a request to shut down the fuel cell system is received; estimate a hydrogen protection time due to a first hydrogen refill operation comprising supplying the hydrogen to the anode side of the fuel cell stack from the hydrogen storage device; and determine, based at least on the estimated duration of the stopover and the hydrogen protection time, whether to enable or disable one or both the first hydrogen refill operation and at least one subsequent hydrogen refill operation.

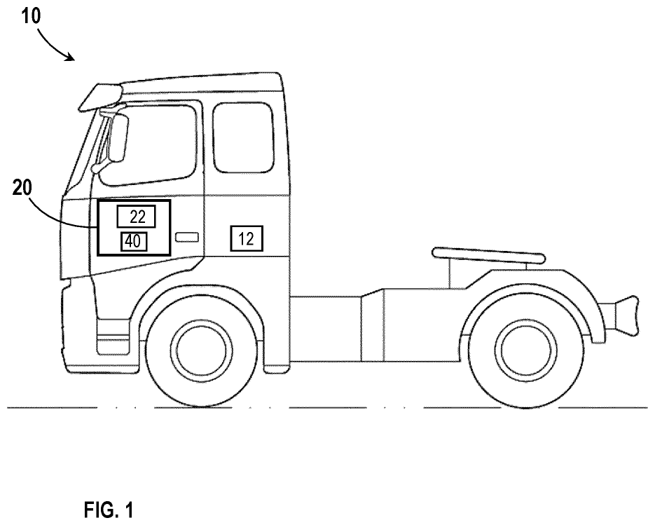

FIG. 1 depicts a side view of a vehicle 10 according to an example of the present disclosure. The vehicle 10 is shown as a truck, such as a heavy-duty truck for towing one or more trailers (not shown). The vehicle 10 may be a fuel cell electric vehicle (FCEV) or a hybrid vehicle comprising a fuel cell system. It should be appreciated that the present disclosure is not limited to any specific type of vehicle, and may be used for any other type of vehicle, such as a bus, construction equipment, e.g. a wheel loader or an excavator, a passenger car, an aircraft, and a marine vessel. The present disclosure is also applicable for other applications not relating to vehicles.

As shown schematically in FIG. 1, the vehicle 10 comprises a fuel cell system 20. The fuel cell system 20 may be used for powering one or more electric drive motors (not shown) which are used for creating a propulsion force to the vehicle 10. The fuel cell system 20 may additionally or alternatively be used for powering other electric power consumers (not shown) of the vehicle 10, such as an electric motor for a crane, an electric motor for a refrigerator system, an electric motor for an air conditioning system, or any other electric power consuming function of the vehicle 10. The fuel cell system 20 may thus additionally or alternatively be used for powering a power take-off (PTO) device that is a device that transfers an electric motor's mechanical power to another piece of equipment. The vehicle 10 may include or be coupled to or associated with one or more PTO devices.

The fuel cell system 20 comprises two or more fuel cells which together form a fuel cell stack 22 as shown in FIG. 1. The fuel cell system 20 is arranged to provide the fuel cells with necessary supply of hydrogen gas (H₂) and air, cooling, heating, etc., and the fuel cell system may include various components which are not shown herein. The fuel cell system 20 may comprise multiple fuel cell systems, and each fuel cell system may comprise its own control system, which may be communicatively connected to a controller or control system. The fuel cell system 20 may comprise a single fuel cell system, two fuel cell systems, or more than two fuel cell systems, such as three or more fuel cell systems. In some examples, the vehicle 10 comprises two fuel cell systems 20. Furthermore, when two or more fuel cell units or systems are provided, the fuel cell systems may be either independently controllable or commonly controllable. When independently controllable, each fuel cell system may be controlled to an on-state or an off-state regardless of the state(s) of the other fuel cell system(s). When two or more of the fuel cell systems are commonly controllable, those fuel cell systems are controllable in common to an on-state or an off-state, i.e., all fuel cell systems are controlled in common to the same state. Two fuel cell systems may in some cases be controlled in dependence on one another, such that one of the fuel cell systems is controlled to be in an on-state or an off-state in dependence on the state of the other fuel cell systems.

The vehicle 10 further comprises a controller or control system 40 according to an example of the present disclosure. The control system 40 may be e.g. an electronic control unit (ECU). The control system 40 may include a microprocessor, microcontroller, programmable digital signal processor or another programmable device. Thus, the control system 40 typically comprises electronic circuits and connections as well as processing circuitry such that the control system can communicate with different parts of the fuel cell system or any other components of the vehicle in order to provide the functions of the examples in accordance with aspects of the present disclosure. The processing circuitry may be a general purpose processor or a specific processor.

Even though an on-board control system 40 is shown, it shall be understood that the control system 40 may be a remote control system 40, i.e. an off-board control system, or a combination of an on-board and off-board control system or systems. In some examples, the control system 40 is an on-board system which is separate from the fuel cell system 20. The control system 40 may be configured to control the fuel cell system 20 by issuing control signals and by receiving status information relating to the fuel cell system 20. The control system 40 may be configured to receive information from various sensors, including one or more of temperature sensors, moisture sensors, and other sensors included in or associated with the fuel cell system 20 and/or the vehicle 10. For example, a temperature sensor may be positioned so as to measure a temperature of the fuel cell stack 22. A temperature sensor may be positioned such that it can measure an ambient temperature (i.e. a temperature outside and/or in the vicinity of the vehicle) that reflects a temperature to which the fuel cell system 20 is subjected. Various sensors may acquire measurements regarding internal operation of the fuel cell system 20.

The control system 40 may also be communicatively coupled to an internal database, an external database, or a combination thereof, to receive historical data related to driver's driving pattern, historical data on the vehicle operation e.g. locations traveled by the vehicle, frequency and locations of stops, historical data on ambient conditions, etc. The control system 40 may further receive data from a weather service which may include data on predicted weather conditions, and other types of data. The data on weather conditions, such as actual and/or predicted weather conditions, may include data on environmental conditions such as a vehicle current location, altitude, and wind speeds. Also, the control system 40 may be aware of a location in which the vehicle is stopped and characteristics of the location, such as e.g. whether the vehicle is parked indoors or outdoors. The control system 40 may also receive data from a global positioning system (GPS). The vehicle 10 may be equipped with a GPS device such as a GPS tracker, and the control system 40 may receive information related to a current location of the vehicle 10. The control system 40 may obtain information about traffic and other conditions related to the route traveled by the vehicle. The control system 40 may obtain data from various sources such as, e.g., one or more out of vehicle-to-everything (V2X) infrastructure, a vehicle-to-vehicle (V2V) infrastructure, a dedicated short range communication (DSRC), a vehicle controller area network (CAN), artificial intelligence (AI), Internet of Things (IoT), and combinations thereof. In some examples, the control system 40 may access data stored in a cloud storage.

In the example of FIG. 1, the control system 40 is shown as part of the fuel cell system 20. In some implementations, the control system 40 may be separate from the fuel cell system 20. Thus, the control system 40 may be an on-board controller or in some implementations it may be an off-board controller, or implemented as a combination thereof.

The control system 40 is an electronic control unit and it comprises processing circuitry which is adapted to execute a computer program such as computer-executable instructions, to perform a method according to aspects of the present disclosure. The control system 40 may comprise hardware and/or software for performing the method according to aspects of the present disclosure. The control system 40 may be denoted a computer. The control system 40 may be constituted by one or more separate sub-units, and the control system 40 may communicate by use of wired and/or wireless communication technology.

As shown in FIG. 1, the vehicle 10 comprises an electrical storage system (ESS) 12 such as e.g. one or more rechargeable batteries for storing electric energy, including excess electric energy produced by the fuel cell system 20. In some examples, the ESS 12 may comprise one or more batteries and/or one or more supercapacitors. The ESS 12 may store energy regenerated during braking such as regenerative braking, and/or it may be configured for charging by a charger, such as, e.g., from an external power grid. The ESS 12 is configured to assist the fuel cell system in supplying energy to the electric drive motor, to meet power/energy demands of the vehicle 10. The ESS 12 may be configured to provide additional propulsive power in situations when the complete required power cannot be provided by fuel cell system 20 or when it is not suitable to provide the complete required power by the fuel cell system 20. In various examples, the ESS 12 may provide electrical energy storage during regenerative braking, provide electrical energy storage for electrical energy that is generated from a fuel cell system at low loads, assist the fuel cell system 20 with generating power at higher loads, or may serve as a main energy supplier in some circumstances. The fuel cell system 20 and the ESS 12 can provide power to one or more auxiliary systems of the vehicle 10.

The vehicle 10 may also comprise various other components not shown in FIG. 1.

Although the present disclosure is described with respect to a vehicle such as a truck, aspects of the present disclosure are not restricted to this particular vehicle, but may also be used in other vehicles such as passenger cars, off-road vehicles, aircrafts and marine vehicles. The present disclosure may also be applied in vessels and in stationary applications, such as in grid-connected supplemental power generators or in grid-independent power generators.

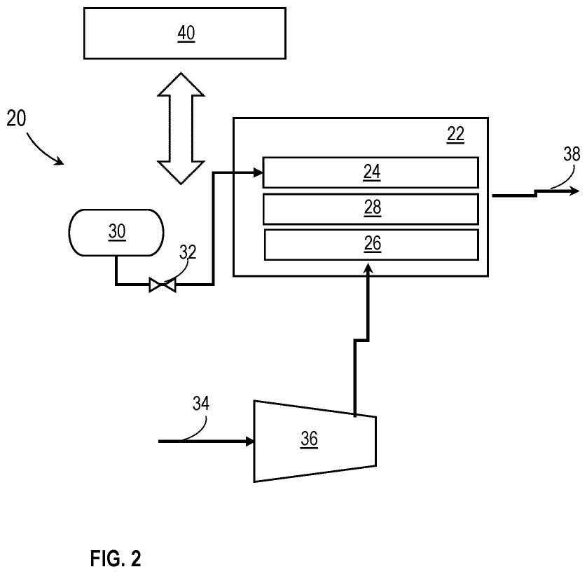

FIG. 2 additionally illustrates an example of the fuel cell system 20. As shown, the fuel cell system 20 comprises a fuel cell stack 22 comprising an anode or anode side 24, a cathode or cathode side 26, and an electrolyte 28 such as e.g. a proton exchange membrane (PEM) sandwiched between the anode side 24 and the cathode side 26. The anode side 24 receives fuel such as e.g. hydrogen gas that can be supplied from a hydrogen storage device 30 e.g. a hydrogen storage container or tank. The supply of hydrogen from the hydrogen storage device 30 may be controlled by a valve 32 shown in FIG. 2 by way of example, or via another component. The valve 32 may be e.g. a proportional valve or any type of valve. The control system 40 may control operation of the valve 32 and/or other component configured to operate to supply hydrogen from the hydrogen storage device 30 to the anode side 24.

The hydrogen is supplied to the anode side 24 during normal operation of the fuel cell system 20, i.e. when the fuel cell system 20 generates electrical energy. The hydrogen can also be supplied to the anode side 24 in a hydrogen refill operation when the fuel cell system 20 is not operating to generate electrical energy, to ensure that the anode side 24 has sufficient amount of hydrogen to prevent an occurrence of an air-to-air start. Regardless of the specific way in which the control of hydrogen supply to the anode side 24 in a hydrogen refill operation is implemented, in aspects of the present disclosure, it is determined whether to enable or disable a hydrogen refill operation during which a certain amount of hydrogen is supplied to the anode side 24. A hydrogen refill operation may be a first hydrogen refill operation that creates hydrogen protection and thus starts a hydrogen protection time. A hydrogen refill operation may be a subsequent hydrogen refill operation that extends or prolongs the hydrogen protection time.

The cathode side 26 receives air from the ambient environment, as shown by line 34. The ambient air may be filtered, and it is pressurized by a compressor 36. The compressed air may be humidified using a humidifier (not shown).

As also shown schematically in FIG. 2, the fuel cell stack 22 has an exhaust conduit 38 configured to carry away from the fuel cell stack 22 an exhaust flow such as byproducts of operation of the fuel cell stack 22. The exhaust flow comprises liquid water, water vapor, oxygen, nitrogen, and hydrogen emitted from the anode side 24. It should be appreciated that of the anode and cathode sides 24, 26 can have respective separate exhaust conduits (not shown), and flows carried in the conduits may be combined into a common flow, e.g. as shown by the exhaust conduit 38. In some examples, the separate exhaust conduits carry the respective exhaust flows from the anode and cathode sides 24, 26 away from the fuel cell stack, and examples herein are not limited to any specific way in which the byproducts of operation of the fuel cell stack are expelled to the environment and/or reused in a suitable way. Accordingly, other ways to collect and further handle fluids and gases emitted by the fuel cell stack can be used.

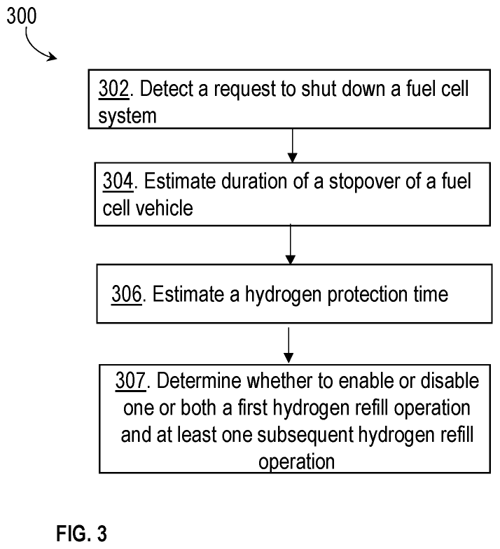

FIG. 3 is a flow chart illustrating a method 300 for controlling operation of a fuel cell system of a fuel cell vehicle such as fuel cell system 20 in vehicle 10, in accordance with an example of the present disclosure. The fuel cell system 20 comprises a fuel cell stack 22 comprising the anode side 24 and the cathode side 26, and the hydrogen storage device 30 for storing hydrogen supplied to the anode side 24 of the fuel cell stack 22. The fuel cell system 20 is configured to generate electrical power or electricity through electrochemical reaction between hydrogen supplied to the anode side 24 and an oxidizing agent such as air or oxygen supplied to the cathode side 26. The method 300 may be performed by a control device or controller, such as e.g. control system 40 shown in FIGS. 1 and 2. Processing circuitry of the control system 40 may perform the process or method 300.

At block 302, the method 300 comprises detecting a request to shut down the fuel cell system. The request for a shutdown of the fuel cell system may be detected, received, or obtained, e.g., when the vehicle is keyed off or a similar input is received indicating that the vehicle has stopped, and the fuel cell system may subsequently be shutdown. The request for the shutdown of the fuel cell system may be received, e.g., as input received from an operator such as e.g. a driver of the vehicle, or in another manner. The detection of the request for the shutdown of the fuel cell system may take place before the actual shutdown of the fuel cell system.

Shutting down the fuel cell system includes disconnecting the fuel cell stack from a load or electrical device, such as an electric drive motor for propelling the vehicle and auxiliary devices consuming power generated by the fuel cell system, and stopping the flow of air into the cathode side. Other processes can be performed as part of the shutdown of the fuel cell system.

At block 304, the method 300 comprises estimating a duration of a stopover of the vehicle. The duration of the stopover, i.e. for how long the vehicle is expected to be stopped until it is started next, may be estimated based on one or more out of a current location of the vehicle, historical data related to operation of the device and driver behaviour, and driver input. For example, from prior use of the vehicle, it may be known that the vehicle is typically parked overnight at the current location. The duration of the vehicle stopover may be determined from a time when the vehicle has been stopped. In some examples, the request for a shutdown of the fuel cell system may be received after the vehicle has been stopped. In the stopped or stopover mode, the vehicle is not moving. When the vehicle is not moving, parking mode may be engaged, e.g. parking brakes may be on. It should be noted that the request for a shutdown of the fuel cell system may be received before, simultaneously with, or after the vehicle has been stopped.

The duration of the stopover of the vehicle may be determined or estimated when the request to shut down the fuel cell system is received. In some examples, the duration of the stopover of the vehicle may be determined or estimated, in part or entirely, responsive to the vehicle stopping and before the request to shut down the fuel cell system is received.

In some examples, estimating the duration of the stopover of the vehicle includes using a multiplier M1, to account for inaccuracies in the estimation of the duration of the stopover of the vehicle. A value of the estimated duration of the stopover of the vehicle may be multiplied by a value of M1. The value of the multiplier M1 may vary in a range of from 0.9 to 1.1, where a value of the multiplier M1 that is closer or equal to 1 is indicative of a greater confidence in the estimation of the duration of the stopover of the vehicle. As an example, M1 of 0.9 or close to 0.9 would be used when a shorter duration of the stopover of the vehicle than an actual duration is considered, and M1 of 1.1 or close to 1.1 would be used when a longer duration of the stopover of the vehicle than the actual duration is considered. The multiplier M1 may be used, e.g., in cases were, based on historical data, the duration of the stopover of the vehicle was underestimated. In an example, the multiplier M1 having a value of greater than 1, e.g. closer to 1.1, may be used as a margin, taken in a case when the vehicle stopover ends later than the estimated duration of the stopover.

At block 306, the method 300 comprises estimating a hydrogen protection time at least due to a first hydrogen refill operation comprising supplying the hydrogen to the anode side of the fuel cell stack from the hydrogen storage device. In some examples, the initial or first hydrogen refill operation, or first hydrogen refill, may be performed as part of the fuel cell system shutdown procedure. Thus, the anode side of the fuel cell stack may be pressurized with hydrogen gas. In some examples, the first hydrogen refill may be performed after the fuel cell system shutdown procedure. For example, the first hydrogen refill may be performed a few seconds after the shutdown of the fuel cell system. The hydrogen protection time may be created due to, i.e. as a result of, the first hydrogen refill operation.

The hydrogen protection time is defined as a period of time within which a restart of the fuel cell system is possible without provoking an air-to-air start. In other words, the hydrogen protection time indicates for how long, after a current time, a sufficient amount of hydrogen gas remains at the anode side of the fuel cell system such that the fuel cell system is protected from a risk of an air-to-air start once the fuel cell system is restarted. The hydrogen protection time may be measured from a time when the request to shut down the fuel cell system is detected. The hydrogen protection time may also be measured from a time when a first or another most recent hydrogen refill was performed. For example, when more than one hydrogen refill is performed, it may be determined by how long a hydrogen protection time is extended by each subsequent refill. Accordingly, for each time instance during a time period when the fuel cell system is shut down, it may be estimated for how long an existing hydrogen protection time is expected to last.

In examples herein, estimating the hydrogen protection time may comprise estimating one or more of a hydrogen protection time that occurs naturally i.e. when no hydrogen refill is performed, the hydrogen protection time that is due to the first hydrogen refill, and a hydrogen protection time that involves increasing or extending an existing hydrogen protection time by each subsequent refill. All three of these types of the hydrogen protection time may be estimated and used to determine whether or not to perform one or more hydrogen refills during the stopover of the vehicle, as discussed below. Accordingly, in addition to estimating the hydrogen protection time due to the first hydrogen refill operation, one or both the so-called natural hydrogen protection time and the hydrogen protection time due to, or created by, one or more subsequent hydrogen refills may be estimated.

The natural hydrogen protection time without any refill, i.e. neither a first refill or a subsequent refill, may be very short or close to zero. This can occur in a normal, i.e. not emergency, shutdown of the fuel cell system. In some cases, some hydrogen may remain at the anode side upon a shutdown of the fuel cell system, and it may provide some limited protection from an air-to-air start. In some cases, there may be no hydrogen in the anode side at the fuel cell system shutdown that would be sufficient to provide hydrogen protection from a potential air-to-air start.

The hydrogen protection time created by the initial or first hydrogen refill may or may not be followed by one or more subsequent hydrogen refills. The hydrogen protection time created by the first refill may be estimated by taking into account the natural hydrogen protection time that, if any, may exist upon the shutdown of the fuel cell system.

The first hydrogen refill may be performed as part of the shutdown procedure, as the fuel cell system is being shut down.

The hydrogen protection time due to, or created by, the first refill may be extended or prolonged by one or more subsequent hydrogen refills. There may be multiple refills, e.g., refills may be controlled to occur at certain time intervals, to ensure that the hydrogen protection time does not expire during the shutdown of the fuel cell system. In some examples, the estimation of the hydrogen protection time involves estimating or determining an additional time which may be added to the hydrogen protection time created by the first refill, to extend this hydrogen protection time, by each subsequent hydrogen refill. In other words, it may be determined to what extent a hydrogen refill would prolong the hydrogen protection time created by one, i.e. the first refill. In some examples, the additional time may be similar for each subsequent refill, such that each subsequent refill is expected to extend a current hydrogen protection time by a similar amount of time unless ambient conditions change sufficiently to affect this. Thus, it may be estimated by how much a hydrogen protection is extended by each refill and by all of the one or more refills that may be performed.

In some cases, a subsequent refill may extend a current hydrogen protection time, e.g. created due to the first refill or due to the first refill plus one or more subsequent refills, by an amount of time that is smaller than a duration of the hydrogen protection created by the first refill.

A hydrogen refill operation increases the hydrogen gas concentration on the anode side and thus extends the hydrogen protection time. The hydrogen protection time depends on environmental conditions such as a vehicle current location, actual and predicted ambient conditions at the current location such as a temperature, altitude, wind speed, etc. For example, the hydrogen protection time may depend on whether the vehicle is parked indoors or outdoors. As another factor, the hydrogen protection time may depend on a configuration of the fuel cell system. As hydrogen at the anode side of the fuel cell stack of the fuel cell system dissipates with time, the remaining duration of the hydrogen protection time decreases.

In some examples, estimating the hydrogen protection time includes using a multiplier M2, to account for inaccuracies in the estimation of hydrogen protection start time. A value of the estimated hydrogen protection time may be multiplied by a value of M2. In some examples, the value of the multiplier M2 may vary in a range of from 0.9 to 1.1, where a value of the multiplier M2 that is closer or equal to 1 is indicative of a greater confidence in the estimation of the hydrogen protection time. As an example, M2 of 0.9 or close to 0.9 would be used when a shorter duration of the hydrogen protection time than an actual hydrogen protection time is considered, and M2 of 1.1 or close to 1.1 would be used when a longer duration of the hydrogen protection time than the actual hydrogen protection time is considered. The multiplier M2 may be used, e.g., in cases were, based on historical data, the hydrogen protection time was underestimated. In an example, the multiplier M2 having a value of greater than 1, e.g. closer to 1.1, may be used as a margin, taken in a case when the hydrogen protection time expires later than it was estimated. The multiplier M2 is independent of a value and use of the multiplier M1, which may be used in some examples to account for inaccuracies in the estimation of the duration of the stopover of the vehicle.

At block 307, the method 300 comprises determining, based at least on the estimated duration of the stopover of the vehicle and the estimated hydrogen protection time, whether to enable or disable one or both a first hydrogen refill operation and at least one subsequent hydrogen refill operation comprising supplying the hydrogen to the anode side of the fuel cell stack from a hydrogen storage device. In this way, an appropriate way to shut down the fuel cell system, i.e. with or without one or more hydrogen refills, is determined.

In some examples, neither the first hydrogen refill operation nor any subsequent hydrogen refill operation is performed. This may occur, for example, when the vehicle is stopped only for a short duration of time. In some examples, as described below, both a first hydrogen refill and any subsequent hydrogen refills may be disabled when an estimated cost of hydrogen required for the refills exceeds an expected degradation cost of the fuel cell system due to a possible air-to-air start.

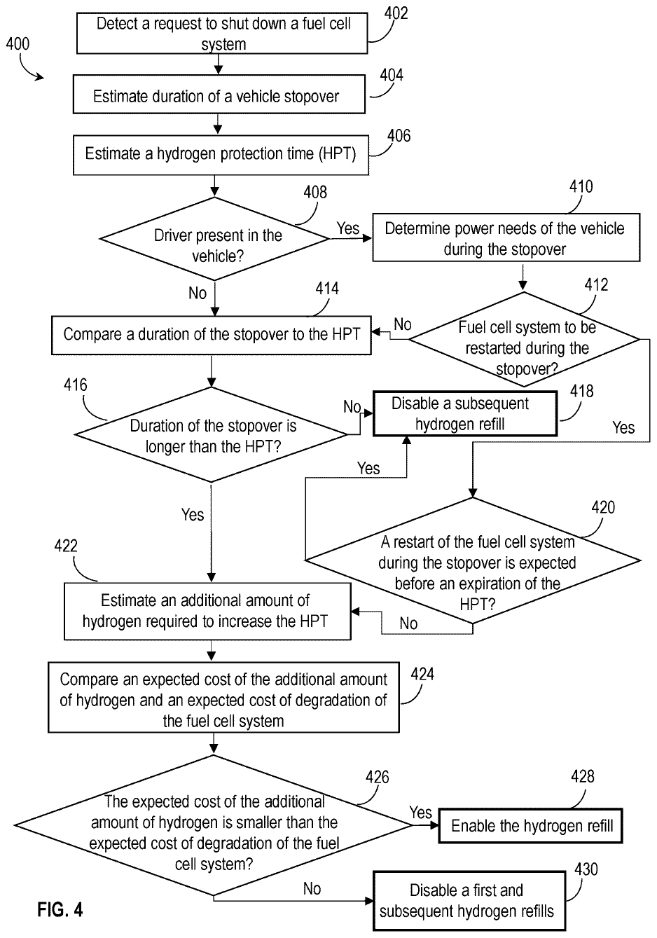

In some cases, only a first hydrogen refill operation is performed at the shutdown of the fuel cell system. At least one e.g., one or more subsequent hydrogen refill operations may or may not be performed. The process of determining whether to enable or disable one or both the first hydrogen refill operation and the at least one subsequent hydrogen refill operation is discussed in more detail below, in connection with FIG. 4.

FIG. 4 is a flow chart illustrating a method or process 400 for controlling operation of a fuel cell system of a fuel cell vehicle such as fuel cell system 20 in vehicle 10, in accordance with an example. FIG. 4 illustrates further details of the method 300 shown in FIG. 3, and the description of processes of FIG. 3 applies to the corresponding processes of FIG. 4, and the description of such processes may therefore not be repeated. The method 400 may be performed by a control device or controller, such as e.g. control system 40 shown in FIGS. 1 and 2. It should be noted that the order of processing at acts or blocks of FIG. 4 is shown as an example, and that the processing at the acts or blocks of FIG. 4 may be performed in any suitable order.

At block 402, the process 400 comprises detecting a request to shut down the fuel cell system. The processing at block 402 is similar to processing at block 302 of FIG. 3. The request for a shutdown of the fuel cell system may be detected, e.g., when the vehicle is keyed off or a similar input is received indicating that the vehicle has stopped, and the fuel cell system is subsequently shut down. The request for a shutdown of the fuel cell system may be received or detected when the vehicle is at a certain location, referred to as a current location i.e. the location of the stopover of the vehicle. When the vehicle is stopped, i.e. it is parked, the fuel cell system of the vehicle may continue operating, for example, to supply power to auxiliary power take-off devices, or to allow certain procedures related to preparation of the fuel cell system for a shutdown to be performed. Thus, the fuel cell system may be shut down after the vehicle is stopped. In addition, in some cases the fuel cell system may be instructed to shut down before the vehicle is stopped, e.g. in anticipation of an upcoming stop of the vehicle.

Shutting down the fuel cell system includes disconnecting the fuel cell stack from a load or electrical device, such as an electric drive motor for propelling the vehicle and/or other power consumers, and stopping the flow of air into the cathode side. Other processes can be performed as part of the shutdown of the fuel cell system, and a shutdown typically includes a sequence of operations that may depend on characteristics of the fuel cell system. Other factors, such as e.g., ambient conditions, may be taken into consideration.

There may be a delay between a time when the request for the shutdown of the fuel cell system is detected and a time when the fuel cell system is actually shut down. For example, in some cases, after the request for the shutdown of the fuel cell system is received or detected, it may take from 30 to 60 seconds, or another time delay, before the fuel cell system is shut down. After the shutdown is complete, the fuel cell system may report the occurrence of the shutdown as a status. The control system 40 thus becomes aware of the fuel cell system being shut down.

The processing in some of the acts or blocks of FIG. 4 may be performed after the request for the shutdown of the fuel cell system is received or detected, and before the fuel cell system is shut down. In some examples, parts of the process 400 may be performed before the request for the shutdown of the fuel cell system is received or detected, and/or the control system 40 may use in performing the process 400 data that is available before the request for the shutdown of the fuel cell system is received or detected.

At block 404, the process 400 comprises estimating or determining a duration of a stopover of the vehicle. The processing at block 404 is similar to processing at block 304 of FIG. 3. The duration of the stopover is defined as a time until a next start of the vehicle or a duration of time, from the time the vehicle is stopped, during which the vehicle is expected to remain to be stopped. The duration of the stopover may be estimated based on one or more out of a current location of the vehicle, historical data related to operation of the device and driver behaviour, and driver input. Various other factors may be used by the control system 40 to estimate the duration of the stopover of the vehicle.

In some examples, the duration of the stopover of the vehicle is estimated using at least one of the driver input and historical data. Other data may also be used. In some examples, additionally or alternatively, the duration of the stopover of the vehicle is determined or estimated using information on a location of the vehicle e.g. the current location of the vehicle. In some examples, it may be known from prior use of the vehicle and/or driver history that the vehicle is typically parked for a certain duration of time at the current location. For example, from prior use of the vehicle and/or driver history, it may be known that the vehicle is typically parked overnight at the current location. Thus, depending on a current time, the control system may determine that the vehicle will be parked at the current location until the following morning or for any predetermined duration of time.

In some examples, the duration of the stopover of the vehicle may be determined using driver input, for example, an explicit driver input indicating the duration of the stopover of the vehicle. For example, the driver may indicate, via a vehicle input device, or via a driver's device such as a smartphone, or in any other way, the duration of the stopover of the vehicle e.g. in the form of a time of the next start of the vehicle or in another form or format.

In some examples, the driver may be instructed that the vehicle remains in the current location for a certain duration of time. This may be case, for example, when the current location is a mandatory stop location for the vehicle, according to regulations. In some examples, the duration of the vehicle stop may depend on a duration of time during which the driver has been driving up until the stop. If it is time for a mandatory break, i.e. rest, for the driver, the duration of the vehicle stop may be determined as a duration of the mandatory break.

Also, some unexpected circumstances may affect a duration of the stopover of the vehicle. For example, the vehicle may require repairs, or there may be weather-related delays. As another example, the control system 40 may obtain information on traffic along a route planned for the vehicle and this information may be used to determine the duration of the stopover of the vehicle. The duration of the stopover of the vehicle may be determined in various other ways, and in dependence on various factors.

In some examples, the duration of the vehicle stopover may be determined before the request to shut down the fuel cell system is received. The request to shut down the fuel cell system may be received after the vehicle has stopped, and the duration of the vehicle stopover may be determined at a time or after the vehicle has stopped but before the request to shut down the fuel cell system is received. For example, in cases in which the duration of the vehicle stopover is determined based on a driver input, such input may be received at a time of or shortly after the vehicle stopping. Also, it may be known at the time the vehicle stops that, in the current location and/or a certain time of the day, the vehicle stops for a certain duration of time. The information obtained from the driver input may be used in combination with historical data on one or more of driver's behavior, locations of vehicle stops, permitted times for driver operating the vehicle without a stop, etc.

In some examples, the duration of the vehicle stopover may be determined after the request to shut down the fuel cell system is received and before the shutdown of the fuel cell system actually occurs.

In some examples, estimating the duration of the stopover of the vehicle includes using the multiplier M1, to account for inaccuracies in the estimation of the duration of the stopover of the vehicle. A value of the estimated duration of the stopover of the vehicle may be multiplied by a value of M1. In some examples, the value of the multiplier M1 may vary in a range of from 0.9 to 1.1, where a value of the multiplier M1 that is closer or equal to 1 is indicative of a greater confidence in the estimation of the duration of the stopover of the vehicle. As an example, M1 of 0.9 or close to 0.9 would be used when a shorter duration of the stopover of the vehicle than an actual duration is considered, and M1 of 1.1 or close to 1.1 would be used when a longer duration of the stopover of the vehicle than the actual duration is considered. In an example, the multiplier M1 having a value of greater than 1, e.g. closer to 1.1, may be used as a margin, taken in a case when the vehicle stopover ends later than the estimated duration of the stopover. The multiplier M1 may be used, e.g., in cases were, based on historical data, the duration of the stopover of the vehicle was underestimated.

At block 406, the control system estimates a hydrogen protection time (HPT) at least due to a first hydrogen refill operation comprising supplying the hydrogen to the anode side of the fuel cell stack from the hydrogen storage device. The processing at block 406 is similar to processing at block 306 of FIG. 3. The control system may also estimate a hydrogen protection time that occurs naturally i.e. when no hydrogen refill is performed, and a hydrogen protection time that is created by extending an existing hydrogen protection time by one or more subsequent hydrogen refills. For any type of the hydrogen protection time, the hydrogen protection time is defined as an estimated duration of time during which hydrogen, that has been delivered to the anode side when the fuel cell system is shut down, provides protection from an air-to-air start.

Hydrogen protection may be provided by hydrogen that remains at the anode side at the shutdown of the fuel cell system, such that some hydrogen protection may be provided even if the first hydrogen refill is not performed. The first hydrogen refill provides further hydrogen protection. One or more subsequent refills that may occur after the first hydrogen refill, one at a time, provide yet further hydrogen protection and extend the hydrogen protection time.

An amount of hydrogen that is supplied from a hydrogen storage device, e.g., hydrogen storage device 30, to the anode side of the fuel cell system at each refill, may be predetermined, e.g., based on a type and/or configuration of the fuel cell system. Accordingly, in some examples, the control system 40 may be preconfigured with information on the amount of hydrogen that is to be delivered to the fuel cell system via the first refill and any of one or more subsequent refills.

In some examples, the hydrogen protection time is estimated using at least current and predicted ambient conditions. In some examples, the hydrogen protection time depends on environmental conditions such as a vehicle current location, ambient conditions at the current location such as an ambient temperature, altitude, wind speed, etc. The ambient temperature may be actual and/or predicted ambient temperature. The hydrogen protection time may depend on whether the vehicle is parked indoors or outdoors.

In some examples, estimating the hydrogen protection time includes using a multiplier M2, to account for inaccuracies in the estimation of hydrogen protection start time. A value of the estimated hydrogen protection time may be multiplied by a value of M2. In some examples, the value of the multiplier M2 may vary in a range of from 0.9 to 1.1, where a value of the multiplier M2 that is closer or equal to 1 is indicative of a greater confidence in the estimation of the hydrogen protection time. As an example, M2 of 0.9 or close to 0.9 would be used when a shorter duration of the hydrogen protection time than an actual hydrogen protection time is considered, and M2 of 1.1 or close to 1.1 would be used when a longer duration of the hydrogen protection time than the actual hydrogen protection time is considered. In an example, the multiplier M2 having a value of greater than 1, e.g. closer to 1.1, may be used as a margin, taken in a case when the hydrogen protection time expires later than it was estimated.

At decision block 408, the process 400 comprises determining whether a driver of the vehicle is present in the vehicle during the stopover for a certain time period. The determining comprises determining whether the driver of the vehicle is expected to be present in the vehicle during the stopover for the certain time period. In other words, one or both an actual driver presence and an expected driver presence may be determined or estimated. In some examples, determining or estimating whether the driver of the vehicle is expected to be present in the vehicle, during the stopover, for the certain time period, comprises determining whether the driver is expected to be sleeping or living in the vehicle for the certain time period. For example, responsive to detecting that the driver is present in a cabin of the vehicle during nighttime after a certain time has passed since the vehicle had stopped, it may be determined that the driver is sleeping in the vehicle.

The presence of the driver in the vehicle may indicate that the driver is using the vehicle, for purposes other than driving, during the stopover. For example, the driver of a taxi or a long-distance truck may be sleeping in the vehicle during rest periods. The driver may also occupy the vehicle during a work break. In some examples, it may be detected whether the driver is sleeping in the vehicle, e.g., using motion, temperature and other sensors that are configured to monitor driver's status. One or more auxiliary devices may be turned on when the driver is present in the vehicle, e.g., one or more out of an air conditioner, a heater, etc.

The processing at block 408 may be performed, entirely or in part, at a time when the vehicle has stopped or after the vehicle has stopped but before the fuel cell system is shut down. In some cases, the processing may be performed after the request for the shutdown of the fuel cell system is received and before the fuel cell system is shut down.

In some examples, the determining at block 408 may be performed based on a driver input —e.g., the driver may expressly indicate the driver's intent to remain in the vehicle for the certain time period. For example, as the vehicle stops, a driver input may be received that is indicating whether it is expected that the driver will be sleeping in the vehicle during the vehicle stopover. The input may be received by the control system from the driver via an application or an app executed on a driver's personal device, via a vehicle's console, or in another manner. In some examples, the driver input may be received via a Human-Machine Interface (HMI) in the cabin of the vehicle. Data that can be used to determine whether the driver of the vehicle is present in the vehicle, such as e.g. one or more of sensor data and driver's input, may be used to generate an indication to the control system. Furthermore, in some examples, determining whether the driver is expected to be present in the vehicle during the stopover for the certain time period may be determined in part or entirely based on historical data on the driver behavior which may include e.g. data on locations at which the driver is typically sleeping or living in the vehicle or is present in the vehicle for another reason during the vehicle stopover. In some examples, the historical data may be used in combination with data from the driver's input, and/or along with other information.

It should be noted that it may not be required that the driver is actually asleep, but a certain position of the driver and/or other data which may be acquired by one or more sensors may be used to determine that the driver is present in the vehicle for a certain time period. In some examples, a certain time period is a period of time that is longer than a threshold time period, and the determining at block 408 involves determining whether the driver of the vehicle is present in the vehicle during the stopover for a certain time period that is longer than threshold time period. Thus, for example, if the driver enters the vehicle for a short time period, it may not be determined that the driver is present in the vehicle for the purposes of the process 400, since the determining at block 408 is performed to further determine whether the fuel cell system may need to be operational during the stopover. Furthermore, the determining that the driver is present in the vehicle, e.g. living or sleeping in the vehicle, accounts for the possibility that the driver may exit the vehicle for short durations of time during the certain time period at which the driver is determined to be present in the vehicle. As used herein, short durations of time may be durations that are shorter than the entire time period during which the driver is determined to be present in the vehicle.

In addition, it should be appreciated that, even though the present description refers to the driver of the vehicle, a person other than a driver may be present in the vehicle for the certain time period. Thus, the processing at block 408 relates to any person that is referred to herein by way of example as a driver of the vehicle.

At block 410, responsive to determining, at decision block 408, that the driver of the vehicle is present or expected to be present in the vehicle during the stopover for the certain time period, the process 400 comprises determining power needs of the vehicle during the stopover of the vehicle. The vehicle power needs, also interchangeably referred to herein as power/energy needs, during the stopover, with the driver present in the vehicle, may include power/energy requirements of auxiliary electrical devices maintaining environment in the vehicle suitable for the driver's presence, e.g. one or more out of an air conditioning and/or heating system, interior lighting system, a refrigerator, a microwave or another type of oven, etc. In some examples, the power needs of the vehicle during the stopover are determined or estimated based on one or more of ambient conditions, the duration of the vehicle stopover, information on auxiliary electrical devices that are turned on, historical data on use of auxiliary electrical devices of the vehicle including during vehicle stopovers, etc. The ambient conditions, such as e.g. current and/or predicted temperature, humidity, wind speed and direction, etc. may affect the determining of the power needs of the vehicle during the stopover. For example, depending on the outside temperature, the interior of the vehicle may need to be heated or cooled. A number, type, and power requirements of auxiliary electrical devices that are currently used or predicted to be used, e.g. based on their historical use, will influence the amount of power that is required by the vehicle during the stopover when the driver or other person is present in the vehicle.

At decision block 412, the process 400 comprises determining whether the fuel cell system is to be restarted during the stopover to meet the determined power needs of the fuel cell vehicle during the stopover of the vehicle. The fuel cell system may be restarted while the vehicle is still in the stopover mode, i.e. is parked. In some examples, determining whether the fuel cell system is to be restarted during the stopover comprises determining whether an electric energy storage of the vehicle, e.g. ESS 12 (FIG. 1), is capable of fulfilling the determined power needs of the fuel cell vehicle during the stopover of the vehicle. The determined power needs of the fuel cell vehicle may be greater than what the ESS of the vehicle may provide. Thus, the fuel cell system may need to be restarted i.e. turned on during the stopover, to allow the power needs of the vehicle during the stopover to be met.

At block 414, responsive to determining, at decision block 408, that the driver of the vehicle is not present and is not expected to be present in the vehicle during the stopover for the certain time period, the control system may compare the estimated duration of the stopover of the vehicle to the hydrogen protection time. In some examples, the comparison involves comparing the estimated duration of the stopover of the vehicle with the hydrogen protection time that is created due to or by the first hydrogen refill. This hydrogen protection time may take into account a hydrogen protection time that may be provided by hydrogen that remains at the anode side at the fuel cell system shutdown, i.e. what is referred to herein as a natural hydrogen protection time that may exist without any, including the initial one, refills. Such hydrogen protection time may be very short or, in some cases, close to zero, such that no hydrogen protection may be provided without hydrogen refills.

As shown in FIG. 4, responsive to determining, at decision block 412, that the fuel cell system is not to be restarted to meet the determined power needs of the fuel cell vehicle during the vehicle stopover, the process 400 similarly follows to block 414 where the estimated duration of the stopover of the vehicle is compared to the hydrogen protection time due to the first hydrogen refill.

In some cases, the duration of the vehicle stopover is longer than the hydrogen protection time provided by the first hydrogen refill, such that the hydrogen protection time provided by the first hydrogen refill expires before the stopover is finished i.e. before the fuel cell system is restarted. In such cases, it is possible that one or more hydrogen refills may be required, to avoid the fuel cell system being at risk of an air-to-air start.

In some cases, the duration of the vehicle stopover is shorter than the hydrogen protection time due to the first hydrogen refill, and a hydrogen refill may therefore not be required since the fuel cell system is considered to be protected from an air-to-air start during the entire stopover period. Thus, only the initial or first hydrogen refill is performed, at the shutdown of the fuel cell system, to create hydrogen protection and start the hydrogen protection time. The first hydrogen refill may be performed as part of performing the fuel cell system shutdown The fuel cell system is expected to be (re)started before the hydrogen protection time created by the first hydrogen refill expires.

At block 418, responsive to determining at decision block 416 that the duration of the stopover of the vehicle is shorter than the hydrogen protection time due to, or created by, the first hydrogen refill, the process 400 comprises disabling a subsequent hydrogen refill operation. The fuel cell system may then be shut down. The first hydrogen refill may be performed as part of the fuel cell system shutdown procedure. The subsequent hydrogen refill operation is not required because the fuel cell system will be restarted at the end of the stopover before the hydrogen protection time finishes. As used herein, disabling a subsequent hydrogen refill operation refers to not enabling the subsequent hydrogen refill operation i.e. a hydrogen refill operation is not performed by a control device such as e.g. control system 40 during the stopover of the vehicle. In other words, the control system 40 does not instruct the fuel cell system 20 to perform any subsequent hydrogen refills.

Referring back to decision block 412, responsive to determining that the fuel cell system is to be restarted to meet the determined power needs of the fuel cell vehicle during the vehicle stopover, the control system determines, at decision block 420, whether a restart of the fuel cell system during the stopover is expected before an expiration of the hydrogen protection time due to the first hydrogen refill. The restart of the fuel cell system may occur while the vehicle is still parked and is in the stopover mode.

Responsive to determining, at decision block 420, that the restart of the fuel cell system during the stopover is expected before the expiration of the hydrogen protection time due to the first hydrogen refill operation, the process 400 follows to block 418 where the subsequent hydrogen refill operation is disabled and only the first or initial hydrogen refill is performed. Thus, no subsequent hydrogen refills take place.

At block 422, responsive to determining, at decision block 420, that the restart of the fuel cell system during the stopover is not expected after the expiration of the hydrogen protection time created by the first hydrogen refill operation, the process 400 comprises estimating an additional amount of hydrogen required to increase the hydrogen protection time created by the first hydrogen refill operation. The additional amount of hydrogen is an amount of hydrogen that would be spent on one or more subsequent hydrogen refills, after the first hydrogen refill.

Hydrogen delivered to the anode side of the fuel cell stack of the fuel cell system dissipates with time, by reacting with oxygen and/or due to leakage. Because the hydrogen protection time created by the first hydrogen refill operation is expected to expire before the fuel cell system is to be restarted next, the hydrogen protection time due to the first hydrogen refill needs to be increased or extended. Thus, the hydrogen consumption required to fulfill the increased hydrogen protection time, for the vehicle stopover duration, may be estimated. The amount of hydrogen required to fulfill the increased hydrogen protection time comprises an amount of hydrogen that would be spent on one or more subsequent hydrogen refills, after the first hydrogen refill.

As also shown in FIG. 4, the process 400 follows to block 422 from block 416, responsive to determining that the duration of the stopover of the vehicle is greater or longer than the hydrogen protection time created by the first hydrogen refill. At block 422, the additional amount of hydrogen required to increase the hydrogen protection time may be estimated based on a configuration of the fuel cell system and other factors such as, e.g. a volume of the anode side, a maximum hydrogen pressure in the anode side, a number of fuel cell stacks, a number of fuel cell systems, etc.

The additional amount of hydrogen is the amount of hydrogen required to fulfill the hydrogen protection time for the duration of the stopover, such that the hydrogen protection time created by the first hydrogen refill does not expire during the stopover. Determining the additional amount of hydrogen may include determining a number of hydrogen refills required to prolong the hydrogen protection time, created by the first hydrogen refill, for the duration of the stopover. The number of required hydrogen refills may be two, three, four, or in some cases more than four refills.

In some examples, the control system 40 may be preconfigured to control the hydrogen storage device 30 to provide a certain predetermined amount of hydrogen at each refill, i.e. the amount of hydrogen required for each refill would be preconfigured. Accordingly, based on the number of refills required, a total amount of hydrogen required for refills can be determined.

At block 424, an expected cost of the additional amount of hydrogen and an expected cost of degradation of the fuel cell system due to a subsequent air-to-air start of the fuel cell system are compared. The subsequent air-to-air start is a possible air-to-air start and its occurrence may be avoided. In some cases, it may be determined that an air-to-air start may be allowed to occur, i.e. if the hydrogen protection time is allowed to expire, if the cost of the degradation of the fuel cell system due to the air-to-air start does not exceed the cost of hydrogen that would be consumed to avoid the possible air-to-air start. Thus, the processing at block 424 may be performed so that the cost of hydrogen consumption is balanced with what is acceptable as a degradation cost of the fuel cell system. This is performed to determine whether it is reasonable to perform one or more hydrogen refills and thus spend hydrogen gas, or whether, given the circumstances, it is more reasonable to abstain from performing a hydrogen refill and accept a risk of an air-to-air start.

The control system 40 may determine the expected cost of the additional amount of hydrogen that would be spent on hydrogen refills after the first refill in dependence on the required amount of the hydrogen, costs associated with hydrogen purchase, storage and/or other factors. The expected cost of the additional amount of hydrogen may be determined, e.g., based on a price at which the hydrogen was refueled last time, considering that the hydrogen prices vary. Depending on the price at which the fuel cell vehicle was refueled last time, it may be determined whether it is reasonable, in terms of costs, to perform a number of refills determined to be required to sufficiently extend the hydrogen protection time. The number of the required hydrogen refills will depend on the estimated duration of the stopover of the vehicle, such that a larger number of refills would be required for a longer stopover of the vehicle.

In some cases, the control system 40 may consider an amount of hydrogen currently in a hydrogen tank, e.g. hydrogen storage device 30 (FIG. 2), possibly in combination with a distance to a hydrogen refueling station or another hydrogen fuel source, in determining the expected cost of the additional amount of hydrogen required for hydrogen refills. For example, the vehicle may be stopped at a location that is far removed from a location of the closest hydrogen refueling station or another location where hydrogen can be acquired for refueling the vehicle, e.g., when the hydrogen tank(s) of the vehicle are replaceable and hydrogen may need to be delivered to the vehicle. In such cases, the control system may consider this factor as increasing the estimated cost of the additional amount of hydrogen, since hydrogen is also required for normal operation of the fuel cell system once the vehicle is started. In some examples, if the current amount of hydrogen in the vehicle hydrogen tank is below a certain threshold amount and if a distance to a hydrogen refueling station is greater than a certain threshold distance, the control system may determine, e.g. in combination with other factors such as the duration of the vehicle stopover, that the expected cost of the additional amount of hydrogen is higher than the expected cost of degradation of the fuel cell system.

The comparison at block 424 considers a need to perform one or more subsequent hydrogen refills, along with the associated cost of the hydrogen, versus cost savings arising from preventing the degradation. In other words, it may be assessed how much is saved, in terms of costs, when one or more hydrogen refills are performed, as compared to a case when the one or more hydrogen refills are not performed and some degradation is permitted. Thus, the comparison is between the cost of degradation arising out of each air-to-air start, which is dependent on the cost of the fuel cell system, and the total cost of hydrogen that would be consumed if one or more refills are performed to prevent an air-to-air start.

In some examples, the cost of degradation of the fuel cell system may be defined as a cost of degradation of a state of health (SoH) of the fuel cell system. The SoH of the fuel cell system may be defined as a remaining lifetime of the fuel cell system. For example, the SoH may be expressed as percentage of the remaining lifetime of the fuel cell system. The cost of degradation of the fuel cell system may be expressed, e.g., as a decrease in a percentage of the remaining lifetime of the fuel cell system. The cost of degradation of the fuel cell system may be expressed in other ways.

The processing at block 424 may also depend on a state of health of the fuel cell system. For example, if the fuel cell system's state of health is close to 100%, it may be acceptable to allow for some degradation of the fuel cell system while saving a costs of hydrogen consumption. On the other hand, if the fuel cell system has a state of health that is below a threshold value 50% or a decision may automatically be made to accept the costs of the consumption of the additional hydrogen while not further decreasing the state of health of the fuel cell system. In some examples, the opposite strategy may be taken, such that a cost of degradation of the fuel cell system may be higher when the fuel cell system's state of health is higher, e.g., 80% or above 80%.

In examples herein, when the number of hydrogen refills that are estimated to be required to fulfill the increased hydrogen protection time is above a certain threshold number of hydrogen refills, it may be determined that the expected cost of the additional amount of hydrogen exceeds the expected cost of degradation of the fuel cell system due to the subsequent air-to-air start of the fuel cell system. In such cases, preventing an air-to-air start, by one or more hydrogen refills and thus consuming hydrogen, may not be justified. In other words, the cost of the hydrogen consumption may be estimated to be excessively high, and a cost of degradation from the air-to-air start of the fuel cell system may be lower and may thus be acceptable. No hydrogen refills may thus be performed. For example, if the fuel cell vehicle is expected to be stopped for several days or a week, or longer, a cost of hydrogen estimated to be required for multiple hydrogen refills during such stopover, may exceed a cost of degradation to the fuel cell system from the air-to-air start of the fuel cell system.

At decision block 426, it is determined whether the expected cost of the additional amount of hydrogen is lower than the expected cost of degradation of the fuel cell system due to the subsequent potential air-to-air start of the fuel cell system. In other words, the processing at block 426 determines whether the increased hydrogen consumption cost is higher than the degradation cost due to the damaging art-to-art restart of the fuel cell system. If this is the case, i.e. the expected cost of the additional amount of hydrogen is lower than the expected cost of degradation of the fuel cell system due to the subsequent air-to-air start of the fuel cell system, the process 400 follows to block 428 where the hydrogen refill operation is enabled which comprises enabling one or more hydrogen refill operations during the shutdown of the fuel cell system.

Accordingly, at block 428, the control system 40 may enable the hydrogen refill operation, such that it instructs the fuel cell system 20 to perform at least one subsequent hydrogen refill operation, in addition to the first hydrogen refill operation. Thus, both the first hydrogen refill operation and the at least one subsequent hydrogen refill operation are enabled. If more than one hydrogen refills determined to be needed at block 422, the refills may be performed e.g. at certain time intervals. Because it has been estimated by how long each hydrogen refill extends the hydrogen protection time, it may be determined with which frequency the refills are to be performed. The fuel cell system may be shut down once the decision is made regarding performing at least one subsequent hydrogen refill operation, in addition to the first hydrogen refill. The first hydrogen refill may be performed as part of the shutdown procedure or, in some cases, it may be a separate process.

At block 430, responsive to determining that the expected cost of the additional amount of hydrogen is not smaller e.g. greater than the expected cost of degradation of the fuel cell system due to the subsequent air-to-air start of the fuel cell system, the control system disables a hydrogen refill operation i.e. no hydrogen refill is not performed. At block 430, the first hydrogen refill is disabled and a subsequent hydrogen refill is also disabled, such that neither the first hydrogen refill nor one or more subsequent refills are performed at the fuel cell system shutdown and while the fuel cell system is shut down during the vehicle stopover.

In some examples, it may be known before shutting down the fuel cell system that an air-to-air start is expected upon a next restart of the fuel cell system. For example, the process 400 may be performed upon the request for the shutdown of the fuel cell system but before the fuel cell system is shut down. In such examples, the control system 40 may modify the shutdown procedure to not include the first hydrogen refill as part of the shutdown or disable the first hydrogen refill. As used herein, the disabling the hydrogen refill may include modifying the shutdown procedure to not include the first hydrogen refill.

In examples herein, when the cost of the hydrogen consumption required for hydrogen refills is estimated to be greater or higher than the expected degradation cost of the fuel cell system due to an air-to-air start, a hydrogen refill operation is not permitted and the fuel cell system's anode side may not be pressurized with hydrogen at the shutdown, since an air-to-air start is expected anyway and there is thus no need to try to prevent it. Thus, responsive to determining that the expected cost of the additional amount of hydrogen is not smaller or greater than the expected cost of degradation of the fuel cell system, the initial or first refill is not performed either. In this way, the hydrogen consumption by the fuel cell system is advantageously decreased, while the durability and of the fuel cell system is maintained. The overall efficiency of operating the fuel cell system is thus improved.

The processing at blocks 408, 410, 412, 414, 416, 418, 420, 422, 424, 426, 428, and 430 of FIG. 4 may be performed as part of processing at block 307 of FIG. 3. As shown in FIG. 4, determining whether to enable or disable one or both the first hydrogen refill operation and the at least one subsequent hydrogen refill operation, e.g. as part of the processing at block 307 of FIG. 3, may comprise disabling a subsequent hydrogen refill operation at block 418, enabling the hydrogen refill operation i.e. both the first hydrogen refill operation and the at least one subsequent hydrogen refill operation at block 428, or disabling both the first hydrogen refill operation and the at least one subsequent hydrogen refill operation at block 430. The processing at blocks 418, 428, and 430 may be performed at the same time as the fuel cell system is being shut down or the processing may be followed by the shutdown of the fuel cell system. In this way, a decision is advantageously made regarding an appropriate way in which one or more hydrogen refills may or may not be performed at the shutdown of the fuel cell system and/or after the fuel cell system has been shut down. Operation costs of the fuel cell system and the vehicle may be reduced, due to balancing the cost of hydrogen consumption for refilling the anode side of the fuel cell system with a degradation cost of the fuel cell system.

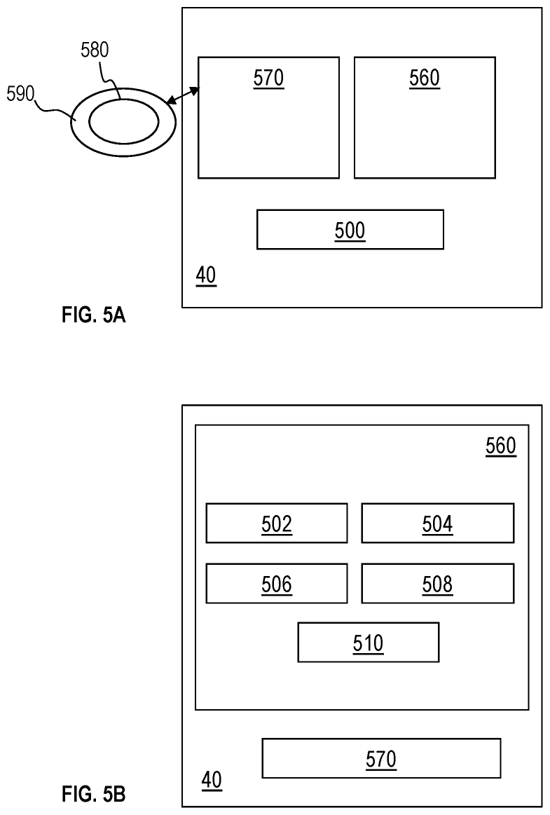

To perform the method steps described herein, the control system 40 may be configured to perform the processing described in connection with FIGS. 3 and 4, and/or any other examples in accordance with aspects of the present disclosure. The control system 40 may, for example, have a configuration as depicted in FIGS. 5A and 5B. The control system 40 may be positioned in any suitable location of the vehicle 10. In some examples, it may be a remote control system or part of its functionality may be performed remotely.

As shown in FIG. 5A, the control system 40 comprises processing circuitry 560, memory 570, and an input and output interface 500 configured to communicate with any necessary components and/or entities of examples herein. The input and output interface 500 may comprise a wireless and/or wired receiver and a wireless and/or wired transmitter. In some examples, the input and output interface 500 may comprise a wireless and/or wired transceiver. The control system 40 may use the input and output interface 500 to control and communicate with various sensors, actuators, subsystems, and/or interfaces of the fuel cell system and the vehicle 10, by using any one or more out of a Controller Area Network (CAN) bus, ethernet cables, Wi-Fi, Bluetooth, and/or other network interfaces.

The methods described herein may be implemented using processing circuitry, e.g., one or more processors, such as the processing circuitry 560 of the control system 40, together with computer program code stored in a computer-readable storage medium for performing the functions and actions of the examples herein.

The memory 570 may comprise one or more memory units. The memory 570 comprises computer-executable instructions executable by the processing circuitry 560 of the control system 40. The memory 570 is configured to store, e.g., information, data, etc., and the computer-executable instructions to perform, when executed by the processing circuitry 560, the methods in accordance with examples herein. The control system 40 may additionally obtain information from an external memory.

The methods according to the aspects of the present disclosure may be implemented by e.g. a computer program product 580 or a computer program, comprising computer-executable instructions, i.e., software code portions, which, when executed by processing circuitry, e.g., the processing circuitry 560, cause the processing circuitry to perform the actions described herein, as performed by the control system 40.

In some examples, the computer program product 580 is stored on a computer-readable storage medium 590. The computer-readable storage medium 590 may be, e.g., a disc, a universal serial bus (USB) stick, or similar device. The computer-readable storage medium 590, having stored thereon the computer program product, may comprise computer-executable instructions which, when executed by the processing circuitry 560, cause the processing circuitry to perform the actions of the methods in accordance with examples of the present disclosure described herein, as performed by the control system 40.

As shown in FIG. 5B, the control system 40 may comprise a detecting unit 502. The control system 40, the processing circuitry 560, and/or the detecting unit 502 may be configured to detect a request to shut down the fuel cell system.

As further shown in FIG. 5B, the control system 40 may comprise an estimating unit 504. The control system 40, the processing circuitry 560, and/or the estimating unit 504 are configured to estimate duration of a stopover of the vehicle when a request to shut down the fuel cell system is received. The control system 40, the processing circuitry 560, and/or the estimating unit 504 are also configured to estimate a hydrogen protection time at least due to a first hydrogen refill operation comprising supplying the hydrogen to the anode side of the fuel cell stack from the hydrogen storage device. In addition to estimating the hydrogen protection time due to the first hydrogen refill operation, the control system 40, the processing circuitry 560, and/or the estimating unit 504 may also be configured to estimate a natural hydrogen protection time. The control system 40, the processing circuitry 560, and/or the estimating unit 504 may also be configured to estimate the hydrogen protection time due to, or created by, one or more subsequent hydrogen refills.

In some examples, the hydrogen protection time, e.g. any of the types of the hydrogen protection time, may be estimated using at least current and predicted ambient conditions.

In some examples, the duration of a stopover of the vehicle may be estimated using at least one of a driver input and historical data. In some examples, the duration of a stopover of the vehicle and the hydrogen protection time may be determined or estimated using information on a location of the vehicle.

The control system 40 may comprise a determining unit 506. The control system 40, the processing circuitry 560, and/or the determining unit 506 are configured to determine, based at least on the estimated duration of the stopover and the hydrogen protection time, whether to enable or disable one or both the first hydrogen refill operation and at least one subsequent hydrogen refill operation. The determining whether to enable or disable one or both the first hydrogen refill operation and the at least one subsequent hydrogen refill operation may comprise disabling a subsequent hydrogen refill operation, enabling the hydrogen refill operation i.e. both the first hydrogen refill operation and the at least one subsequent hydrogen refill operation, or disabling both the first hydrogen refill operation and the at least one subsequent hydrogen refill operation. Disabling the subsequent hydrogen refill operation may involve not performing any subsequent hydrogen refill operation after the first hydrogen refill operation is performed. Disabling both the first hydrogen refill operation and the at least one subsequent hydrogen refill operation may involve not performing any hydrogen refill operation.

In some examples, the control system 40, the processing circuitry 560, and/or the determining unit 506 may further be configured to determine whether a driver of the vehicle is present in the vehicle during the stopover for a certain time period. For example, the control system 40, the processing circuitry 560, and/or the determining unit 506 may be configured to determine whether the driver is sleeping, or expected to sleep, in the vehicle during the during the stopover of the vehicle. Thus, determining whether the driver of the vehicle is present in the vehicle during the stopover for the certain time period may comprise determining whether the driver is sleeping or living in the vehicle. The certain time period may comprise a portion of the stopover, or the entire stopover.

In some examples, the control system 40, the processing circuitry 560, and/or the determining unit 506 may further be configured to, responsive to determining that the driver of the vehicle is present in the vehicle during the stopover for the certain time period, determine power needs of the fuel cell vehicle during the vehicle stopover. In some examples, the control system 40, the processing circuitry 560, and/or the determining unit 506 may further be configured to determine whether the fuel cell system is to be restarted during the stopover to meet the determined power needs of the fuel cell vehicle during the stopover of the vehicle. In some examples, determining whether the fuel cell system is to be restarted during the stopover comprises determining whether an electric energy storage of the vehicle is capable of fulfilling the determined power needs of the fuel cell vehicle during the stopover of the vehicle.

The control system 40 may comprise a comparing unit 508. In some examples, the control system 40, the processing circuitry 560, and/or the comparing unit 508 may be configured to, responsive to determining that the driver is not present in the vehicle during the stopover for the certain time period or responsive to determining that the fuel cell system is not to be restarted to meet the determined power needs of the fuel cell vehicle during the vehicle stopover, compare the duration of the stopover of the vehicle to the hydrogen protection time due to the first hydrogen refill operation.

The control system 40 may comprise an enabling/disabling unit 510, which may also be referred to as a control unit. The control system 40, the processing circuitry 560, and/or the enabling/disabling unit 510 may be configured to enable or disable a hydrogen refill operation, which may be an initial or first hydrogen refill operation, or a subsequent hydrogen refill operation that is performed after the first hydrogen refill operation is performed. In some examples, the control system 40, the processing circuitry 560, and/or the enabling/disabling unit 510 may be configured to, responsive to determining that the duration of the stopover of the vehicle is shorter than the hydrogen protection time, disable the at least one subsequent hydrogen refill operation.

In some examples, the control system 40, the processing circuitry 560, and/or the determining unit 506 may further be configured to, responsive to determining that the fuel cell system is to be restarted to meet the determined power needs of the fuel cell vehicle during the vehicle stopover, determine whether a restart of the fuel cell system during the stopover is expected before an expiration of the hydrogen protection time due to the first hydrogen refill operation.

In some examples, the control system 40, the processing circuitry 560, and/or the enabling/disabling unit 510 may further be configured to, responsive to determining that the restart of the fuel cell system during the stopover is expected before the expiration of the hydrogen protection time, disable the at least one subsequent hydrogen refill operation. Thus, the first hydrogen refill operation is performed whereas no refills take place.

In some examples, the control system 40, the processing circuitry 560, and/or the estimating unit 504 may be configured to, responsive to determining that the duration of the stopover of the vehicle is greater than the hydrogen protection time or responsive to determining that the restart of the fuel cell system during the stopover is expected after the expiration of the hydrogen protection time, estimate an additional amount of hydrogen required to increase the hydrogen protection time due to the first hydrogen refill.

In some examples, the control system 40, the processing circuitry 560, and/or the comparing unit 508 may be configured to compare an expected cost of the additional amount of hydrogen required to increase the hydrogen protection time due to the first hydrogen refill and an expected cost of degradation of the fuel cell system due to a subsequent air-to-air start of the fuel cell system. The control system 40, the processing circuitry 560, and/or the enabling/disabling unit 510 may further be configured to enable the first hydrogen refill operation and the at least one subsequent hydrogen refill operation responsive to determining that the expected cost of the additional amount of hydrogen is lower than the expected cost of degradation of the fuel cell system due to the subsequent air-to-air start of the fuel cell system.

In some examples, the control system 40, the processing circuitry 560, and/or the enabling/disabling unit 510 may be configured to disable both the first hydrogen refill operation and the at least one subsequent hydrogen refill operation responsive to determining that the expected cost of the additional amount of hydrogen is greater than the expected cost of degradation of the fuel cell system due to the subsequent air-to-air start of the fuel cell system.

Those skilled in the art will appreciate that the units in the control system 40 described above may refer to a combination of analogue and digital circuits, and/or one or more processors configured with software and/or firmware, e.g., stored in the control system 40, that, when executed by the respective one or more processors, may perform the methods in accordance with examples of the present disclosure. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A method for controlling operation of a fuel cell system of a fuel cell vehicle the fuel cell system comprising a fuel cell stack comprising an anode side and a cathode side, and a hydrogen storage device for storing hydrogen supplied to the fuel cell stack, the method comprising:
estimating a duration of a stopover of the vehicle when a request to shut down the fuel cell system is received;
estimating a hydrogen protection time at least due to a first hydrogen refill operation comprising supplying the hydrogen to the anode side of the fuel cell stack from the hydrogen storage device; and
determining, based at least on the estimated duration of the stopover and the hydrogen protection time, whether to enable or disable one or both the first hydrogen refill operation and at least one subsequent hydrogen refill operation.

2. The method of claim 1, further comprising determining whether a driver of the vehicle is present in the vehicle during the stopover for a certain time period.

3. The method of claim 2, further comprising:
responsive to determining that the driver of the vehicle is present in the vehicle during the stopover for the certain time period, determining power needs of the fuel cell vehicle during the vehicle stopover; and
determining whether the fuel cell system is to be restarted during the stopover to meet the determined power needs of the fuel cell vehicle during the stopover of the vehicle.

4. The method of claim 3, wherein the determining whether the fuel cell system is to be restarted during the stopover comprises determining whether an electric energy storage of the vehicle is capable of fulfilling the determined power needs of the fuel cell vehicle during the stopover of the vehicle.

5. The method of claim 2, further comprising, responsive to determining that the driver is not present in the vehicle during the stopover for the certain time period or responsive to determining that the fuel cell system is not to be restarted to meet the determined power needs of the fuel cell vehicle during the vehicle stopover,
comparing the duration of the stopover of the vehicle to the hydrogen protection time due to the first hydrogen refill operation.

6. The method of claim 5, further comprising, responsive to determining that the duration of the stopover of the vehicle is shorter than the hydrogen protection time due to the first hydrogen refill operation, disabling the at least one subsequent hydrogen refill operation.

7. The method of claim 3, further comprising, responsive to determining that the fuel cell system is to be restarted to meet the determined power needs of the fuel cell vehicle during the vehicle stopover, determining whether a restart of the fuel cell system during the stopover is expected before an expiration of the hydrogen protection time due to the first hydrogen refill operation.

8. The method of claim 7, further comprising, responsive to determining that the restart of the fuel cell system during the stopover is expected before the expiration of the hydrogen protection time, disabling the at least one subsequent hydrogen refill operation.

9. The method of claim 5, further comprising, responsive to determining that the duration of the stopover of the vehicle is greater than the hydrogen protection time due to the first hydrogen refill operation or responsive to determining that the restart of the fuel cell system during the stopover is not expected after the expiration of the hydrogen protection start due to the first hydrogen refill operation, estimating an additional amount of hydrogen required to increase the hydrogen protection time due to the first hydrogen refill.

10. The method of claim 9, further comprising:
comparing an expected cost of the additional amount of hydrogen and an expected cost of degradation of the fuel cell system due to a subsequent air-to-air start of the fuel cell system; and
enabling the first hydrogen refill operation and the at least one subsequent hydrogen refill operation responsive to determining that the expected cost of the additional amount of hydrogen is lower than the expected cost of degradation of the fuel cell system due to the subsequent air-to-air start of the fuel cell system.

11. The method of claim 10, further comprising:
disabling both the first hydrogen refill operation and the at least one subsequent hydrogen refill operation responsive to determining that the expected cost of the additional amount of hydrogen is greater than the expected cost of degradation of the fuel cell system due to the subsequent air-to-air start of the fuel cell system.

12. The method of claim 2, wherein determining whether the driver of the vehicle is present in the vehicle during the stopover for the certain time period comprises determining whether the driver is sleeping or living in the vehicle.

13. The method of claim 1, wherein the duration of a stopover of the vehicle is estimated using at least one of a driver input and historical data.

14. The method of claim 1, wherein the hydrogen protection time is estimated using at least current and predicted ambient conditions.

15. The method of claim 13, wherein the duration of a stopover of the vehicle and the hydrogen protection time are estimated using information on a location of the vehicle.

16. A control system for controlling a fuel cell system of a fuel cell vehicle, the control system comprising processing circuitry, and the fuel cell system comprising a fuel cell stack comprising an anode side and a cathode side, and a hydrogen storage device for storing hydrogen supplied to the fuel cell stack, the processing circuitry is configured to:
estimate a duration of a stopover of the vehicle when a request to shut down the fuel cell system is received;
estimate a hydrogen protection time at least due to a first hydrogen refill operation comprising supplying the hydrogen to the anode side of the fuel cell stack from the hydrogen storage device; and
determine, based at least on the estimated duration of the stopover and the hydrogen protection time, whether to enable or disable one or both the first hydrogen refill operation and at least one subsequent hydrogen refill operation.

17. A control system having processing circuitry configured to perform the method of claim 2.

18. A fuel cell vehicle comprising and/or being in communication with the control system of claim 16.

19. A computer program product comprising instructions, which, when executed by processing circuitry, cause the processing circuitry to perform the method of claim 1.

20. A non-transitory computer-readable storage medium, having stored thereon a computer program product comprising instructions which, when executed by processing circuitry, cause the processing circuitry to perform the method of claim 1.
